(19) United States
(12) Patent Application Publication
(10) Pub. No.: US 2010/0231749 A1
(43) Pub. Date: Sep. 16, 2010

(54) IMAGE SIGNAL PROCESSING DEVICE HAVING A DYNAMIC RANGE EXPANSION FUNCTION AND IMAGE SIGNAL PROCESSING METHOD

(76) Inventors: Yukiyasu Tatsuzawa, Yokohama-shi (JP); Yoshitaka Egawa, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/699,360

(22) Filed: Feb. 3, 2010

(30) Foreign Application Priority Data
Mar. 13, 2009 (JP) 2009-060934

(51) Int. Cl. H04N 5/235; H04N 9/68

(52) U.S. Cl. 348/229.1; 348/234; 348/E05.037; 348/E09.053

(57) ABSTRACT

An imaging unit generates first and second image signals imaged using different exposure time based on a reference read voltage. A synthesis circuit synthesizes the first and second image signals generated by the imaging unit. A detection unit detects luminance information of a specified subject using a synthesized image signal outputting from the synthesis circuit. A controller controls the reference read voltage of the imaging unit, the controller determines a first knee point based on luminance information of a specified subject detected by the detection unit, and controls the first knee point according to the reference read voltage.

### CROSS-REFERENCE TO RELATED APPLICATIONS

This application is based upon and claims the benefit of priority from prior Japanese Patent Application No. 2009-060934, filed Mar. 13, 2009, the entire contents of which are incorporated herein by reference.

### BACKGROUND OF THE INVENTION

1. Field of the Invention

The present invention relates to an image signal processing device, which is applied to a digital camera, for example. In particular, the present invention relates to an image signal processing device having a dynamic range expansion function, and to an image signal processing method.

2. Description of the Related Art

An device for expanding the dynamic range of a charge coupled device (CCD) and a CMOS (complementary metal oxide semiconductor) image sensor applied to a digital camera and a digital video camera has been developed (e.g., see JP 2008-271368 and JP 2007-124400).

The JP 2008-271368 discloses the following technique. According to the technique, when imaging is carried out in an exposure setup mode, luminance information, for example, luminance histogram is analyzed. In this case, the luminance histogram is analyzed with respect to a synthetic image generated from long-time and short-time exposure image signals. From the analyzed result, the exposure of the short-time exposure image signal is controlled.

On the other hand, the JP 2007-124400 discloses a double-exposure accumulating operation by a photodiode, division read and linear synthesis of a division read signal. Specifically, the following technique is disclosed. According to the technique, long and short exposure time signals are independently converted to analog-to-digital signals for one horizontal scan period, and then, these signals are output. The output two digital signals are added, and thereby, a reduction of an image quality is prevented so that a dynamic range is expanded.

However, the conventional techniques do not give consideration to each image quality of long- and short-time exposure image signals. Rather, a signal-to-noise ratio (SNR) and a quantization error are relatively preferable in the long-time exposure image signal. Thus, preferably, a specific subject, for example, an important subject such as a human face is controlled so that it is included in the long-time exposure image signal. However, the control is not carried out in the conventional case.

Moreover, a dynamic range of a display device for displaying an image signal is relatively narrow. For this reason, there is a need to narrow the dynamic range in an imaging unit if the display device displays an image signal having an expanded dynamic range. So, the expanded dynamic range is compressed using a dynamic range compression technique, for example, high-luminance knee compression. In also case, it is desired that a knee point is optimized based on the luminance level of an important subject such as a face. However, the control is not taken into consideration in the conventional case. Therefore, it is desired to provide image signal processing device and method, which prevent a reduction of the image quality of an important subject while expanding dynamic range.

### BRIEF SUMMARY OF THE INVENTION

According to a first aspect of the invention, there is provided an image signal processing device comprising: an imaging unit configured to generate first and second image signals imaged using different exposure time based on a reference read voltage; a synthesis circuit configured to synthesize the first and second image signals generated by the imaging unit; a detection unit configured to detect luminance information of a specified subject using a synthesized image signal outputting from the synthesis circuit; and a controller configured to control the reference read voltage of the imaging unit, the controller configured to determine a first knee point based on luminance information of a specified subject detected by the detection unit, and to control the first knee point according to the reference read voltage.

According to a second aspect of the invention, there is provided an image signal processing method comprising: imaging a specified subject based on a reference read voltage; setting luminance information of the specified subject to a target luminance information using exposure control; and determining a first knee point based on the target luminance information, and controlling the reference read voltage according to the first knee point.

According to a third aspect of the invention, there is provided an imaging signal processing method comprising: imaging a specified subject having an expanded dynamic range based on a reference read voltage; setting luminance information of the specified subject to a target luminance information using exposure control; determining a reference read voltage of the dynamic range based on the target luminance information; calculating a luminance histogram of the determined reference read voltage; accumulating the calculated histogram; and determining a dynamic range based on the accumulated histogram and a predetermined selection reference.

### BRIEF DESCRIPTION OF THE SEVERAL VIEWS OF THE DRAWING

FIG. 1 is a block diagram showing the configuration of an image signal processing device according to a first embodiment of the present invention;

FIG. 2 is a view to explain one example of a double-exposure operation in the device shown in FIG. 1;

FIGS. 3A to 3C are views to explain a double-exposure operation in different illumination;

FIG. 4 is a view to explain a double-exposure operation in different illumination;

FIG. 5 is a block diagram showing the configuration of a linear synthesis circuit shown in FIG. 1;

FIG. 6 is a table to explain the relationship between a medium read voltage and a dynamic range expansion mode;

FIG. 7 is a flowchart to explain the operation of the first embodiment;

FIG. 8 is a flowchart to explain the operation according to a modification example of the first embodiment;

FIGS. 9A and 9B are views to explain the operation of the modification example shown in FIG. 8;

FIG. 10 is a block diagram showing the configuration of an image signal processing device according to a second embodiment of the present invention; and

FIG. 11 is a block diagram showing the configuration of a part of the device shown in FIG. 10.

### DETAILED DESCRIPTION OF THE INVENTION

Various embodiments of the present invention will be hereinafter described with reference to the accompanying drawings.

### First Embodiment

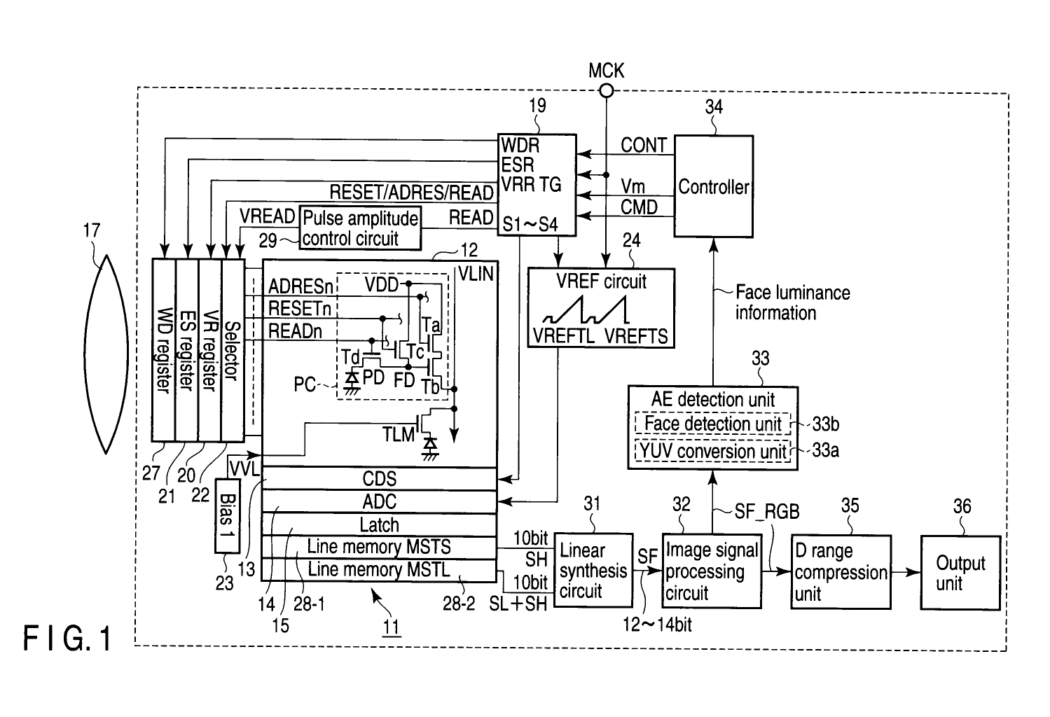

FIG. 1 shows an image signal processing device according to a first embodiment of the invention, for example, the configuration of an amplification CMOS image sensor. First, the configuration of an image signal processing device will be schematically described with reference to FIG. 1.

A sensor core unit 11 includes a pixel unit 12, a CDS 13 functioning as a column noise cancel circuit, a column analog-to-digital converter (ADC) 14, a latch circuit 15 and two line memories (MSTS, MSTL) 28-1 and 28-2.

The pixel unit 12 photoelectrically converts a light, which is incident via a lens 17, and then, generates charges in accordance with the incident light. Further, the pixel unit 12 is provided with a plurality of cells (pixels), which are arrayed like a matrix on a semiconductor substrate (not shown). One cell PC comprises four transistors (Ta, Tb, Tc, Td) and a photodiode (PD). Each cell PC is supplied with pulse signals ADRESn, RESETn and READn. The transistor Tb of each cell PC is connected to a vertical signal line VLIN. One terminal of a current path of a load transistor TLM for a source follower circuit is connected to the vertical signal line VLIN, and the other terminal thereof is grounded.

An analog signal corresponding to signal charges generated from the pixel unit 12 is supplied to the ADC 14 through the CDS 13, and thereafter, converted to a digital signal, and then, latched by the latch circuit 15. The digital signal latched by the latch circuit 15 is successively transferred via line memories (MSTS, MSTL) 28-1 and 28-2. For example, 10-bit digital signals SH and SL+SH read from line memories (MSTS, MSTL) 28-1 and 28-2 are supplied to a linear synthesis circuit 31, and thereafter, synthesized by means of the circuit 31.

The following circuit and registers are arranged adjacent to the pixel unit 12. The arranged circuit is a pulse selector circuit (selector) 22. The arranged registers are a signal read vertical register (VR register) 20, an accumulation time control vertical register (ES register, long accumulation time control register) 21 and an accumulation time control vertical register (WD register, short accumulation time control register) 27.

A timing generator (TG) 19 generates pulse signals S1 to S4, READ, RESET/ADRES/READ, VRR, ESR and WDR in accordance with a control signal CONT and a command CMD supplied from a controller 34 described later.

The pulse signals S1 to S4 are supplied to the CDS circuit 13. The pulse signal READ (including a medium read signal Vm described later) is supplied to a pulse amplitude control circuit 29. The amplitude of the pulse signal READ is controlled by means of the pulse amplitude control circuit 29, and thereby, a three-value pulse signal VREAD is generated, and then, supplied to the selector circuit 22. In addition, the pulse signal RESET/ADRES/READ is supplied to the selector circuit 22. The pulse signal VRR is supplied to the VR register 20, the pulse signal ESR is supplied to the ES register 21 and the pulse signal WDR is supplied to the WD register 27. A vertical line of the pixel unit 12 is selected by means of the registers 20, 21 and 27, and then, the pulse signal RESET/ADRES/READ (typically, shown as RESETn, ADRESn, READn in FIG. 1) is supplied to the pixel unit 12.

In the cell PC, a current path of a row select transistor Ta and an amplification transistor Tb is connected in series between a power supply VDD and the vertical signal line VLIN. The gate of a transistor Ta is supplied with a pulse signal (address pulse) ADRESn. A current path of a reset transistor Tc is connected between the power supply VDD and the gate (detection node FD) of the transistor Tb, and further, the gate thereof is supplied with a pulse signal (reset pulse) RESETn. One terminal of a current path of a read transistor Td is connected to the detection node FD, and further, the gate thereof is supplied with a pulse signal (read pulse) READn. The other terminal of the current path of the read transistor Td is connected with a cathode of a photodiode PD. In this case, an anode of the photodiode PD is grounded. Further, a bias voltage VVL is applied to the pixel unit 12 from a bias generator circuit (bias 1) 23. The bias voltage VVL is supplied to the gate of a load transistor TLM.

A VREF generator circuit 24 generates an analog-to-digital conversion (ADC) reference waveform in response to a main clock signal MCK. The VREF generator circuit 24 generates triangular waves VREFTL and VREFTS to carry out two-timeanalog-to-digital conversions for one horizontal scan period, and thereafter, supplies these waves to the ADC 14.

According to the configuration, for example, in order to read an n-line signal of the vertical signal line VLIN, the pulse signal ADRESn is set to an “H” level to operate the amplification transistor Tb and the load transistor TLM. A signal charge obtained by photoelectric conversion of the photodiode PD is accumulated for a predetermined period. In order to remove a noise signal such as a dark current in the detection node FD before read is carried out, the pulse signal RESETn is set to an “H” level to turn on the transistor Tc, and thereby, the detection node FD is set to a VDD voltage=2.8 V. In this way, a reference voltage (reset level) of a state that no signal is included in the detection node FD is output to the vertical signal line VLIN. A charge corresponding to the reset level of the vertical signal line VLIN is supplied to the ADC 14 via the CDS 13.

The pulse signal (read pulse) READn is set to an “H” level to turn on the read transistor Td. Then, an accumulated signal charge generated by the photodiode PD is read to the detection node FD. In this way, a voltage (signal+reset) level of the detection node FD is read to the vertical signal line VLIN. A charge corresponding to the signal+reset level of the vertical signal line VLIN is subjected to correlated double sampling by means of the CDS 13 so that noise is cancelled, and thereafter, supplied to the ADC 14. Automatic gain control (AGC) processing may be carried out between CDS 13 and ADS 14.

Thereafter, a reference waveform level output from the VREF generator circuit 24 is increased (i.e., triangular wave VREF is changed from a low level to a high level), and thereby, an analog signal is converted to a digital signal by means of the ADC 14. The analog-to-digital conversion operation is carried out two times for one horizontal scan period in accordance with triangular waves VREFTL and VREFTS supplied from the VREF generator circuit 24. For example, the triangular wave is 10 bits (0 to 1023 levels). Output data of the ADC 14 corresponding to triangular waves VREFTL and VREFTS is successively held by means of the latch circuit 15, and then, transferred to line memory MSTS and MSTL. In other words, a wide dynamic range (WDR) sensor executes a double-exposure accumulation operation. Therefore, a long-time exposure signal, that is, an SL signal (sensor output is an SL+SH signal) and a short-time exposure signal, that is, an SH signal are detected. These signals are delayed and adjusted by means of line memories MSTS and MSTL so that timing is matched.

Signal SH held by the line memory MSTS and signal SL+SH held by the line memory MSTSL are supplied to a linear synthesis circuit 31. A signal SF synthesized by the linear synthesis circuit 31 is supplied to an image signal processing circuit 32. The image signal processing circuit 32 executes generally various signal processings, for example, a shading correction, a noise cancel and a de-mosaic processing with respect to an input signal. In this way, the input signal is converted from a Bayer-format signal SF to an RGB-format signal SF_RGB. One output signal of the image signal processing circuit 32 is supplied to an AE detection unit 33 while the other output signal thereof is successively supplied to a dynamic range compression unit (D range compression unit) 35 and an output unit 36.

The AE detection unit 33 includes known YUV conversion unit 33a and face detection unit 33b. Signal SFRGB is converted to a luminance signal (Y), a blue-component color difference signal (U) and a red-component color difference signal (V) by means of the YUV conversion unit 33a. The face detection unit 33b makes face detection with respect to a luminance signal to output face luminance information given as a detected important subject. The luminance information is supplied to a controller 34.

The controller 34 comprises a microprocessor, for example. The controller 34 has an auto-exposure (AE) control function and a function of determining a medium read voltage (Vm). Specifically, the controller 34 execute exposure control so that the luminance is set to a target luminance, for example, 650 LSB based on the supplied face luminance information. Further, when exposure control ends and the face luminance is determined, the controller 34 finds a knee point so that the face becomes a signal SL, and then, determines a Vm value from the knee pint. The controller 34 outputs a command CMD, a control signal CONT and the determined Vm value. The command CMD, control signal CONT and Vm value are supplied to a timing generator (TG) 19. The timing generator 19 generates the various pulse signals based on command CMD, control signal CONT and Vm value.

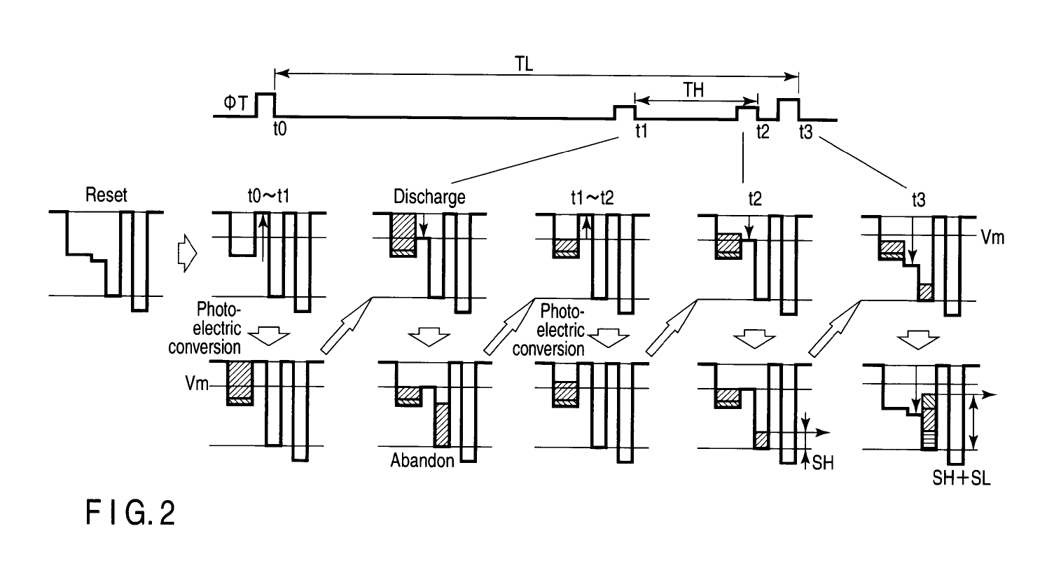

FIG. 2 is a view to explain a double-exposure accumulation operation of the image signal processing device. The double-exposure accumulation operation will be schematically described below with reference to FIG. 2. This operation is divided into the following cases. Specifically, one is the case where illumination is high, that is, high light. Another is the case where illumination is medium, that is, medium light. Another is the case where illumination is low, that is, low light. In FIG. 2, the operation of the typical high light case will be explained.

First, at time to, a reset pulse is released so that exposure (photoelectric conversion) is started. According to the high light case, a charge larger than a set medium read voltage (Vm value) is accumulated in a photodiode. For this reason, at time t1, a charge larger than the medium read voltage (Vm value) is partially transferred, and thus, discharged.

Charge (short-time exposure) is again carried out for a short time (TH) from time t1 to t2. Thereafter, a charge more than the Vm value is partially transferred, and then, detected as a signal SH.

At time t3, charges remaining at time t3 are fully transferred, and then, added to the charge of the detected signal SH, and thus, detected as a signal SL+SH.

In other words, two signals; specifically, a short-time exposure signal, that is, signal SH and the sum of a long-time exposure signal and the short-time exposure signal, that is, signal SL+SH are obtained as a sensor output.

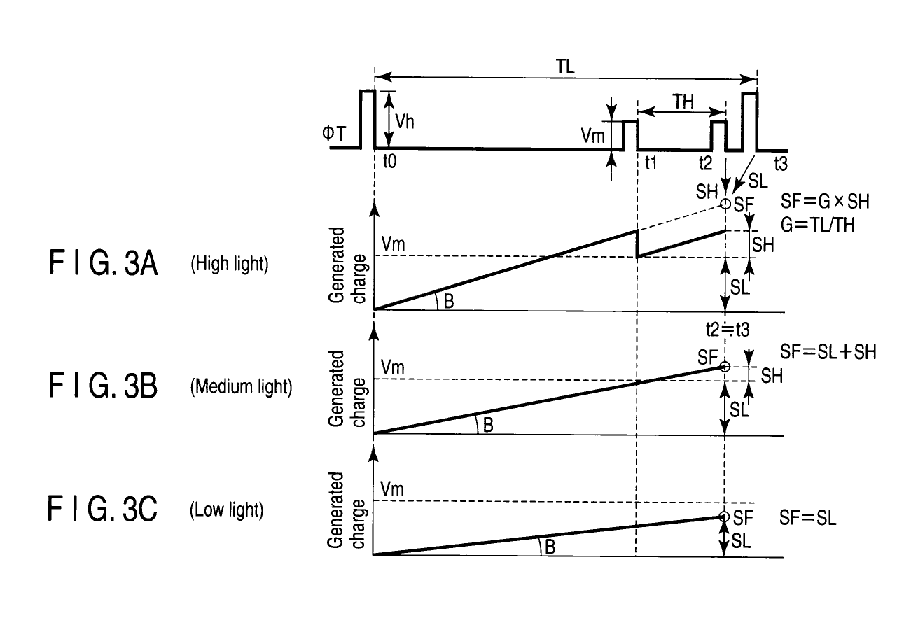

FIGS. 3A to 3C show the signal accumulated state of high light, medium light and low light cases, respectively. A method of calculating a linear synthesis image signal of finally desired long-time exposure signal and short-time exposure signal, that is, a signal SF will be explained below with reference to FIG. 3.

As can be seen from FIG. 3C, according to the low light case, a charge is not accumulated more than a Vm value for exposure time. For this reason, the final synthesis image signal SF is the SL signal itself.

As can be seen from FIG. 3B, according to the medium light case, an accumulated charge does not becomes more than the Vm value at time t1; for this reason, no discharge is carried out. Therefore, the synthesis image signal SF is equal to a signal SL+SH.

As can be seen from FIG. 3A, according to the high light case, the shape of signal SF is congruent with signal SH. Therefore, signal SF is obtained by multiplying an exposure ratio G=TL/TH (TL: long time, TH: short time) by signal SH. Namely, signal SF is obtained from the following equation (1).

SF=G×SH (1)

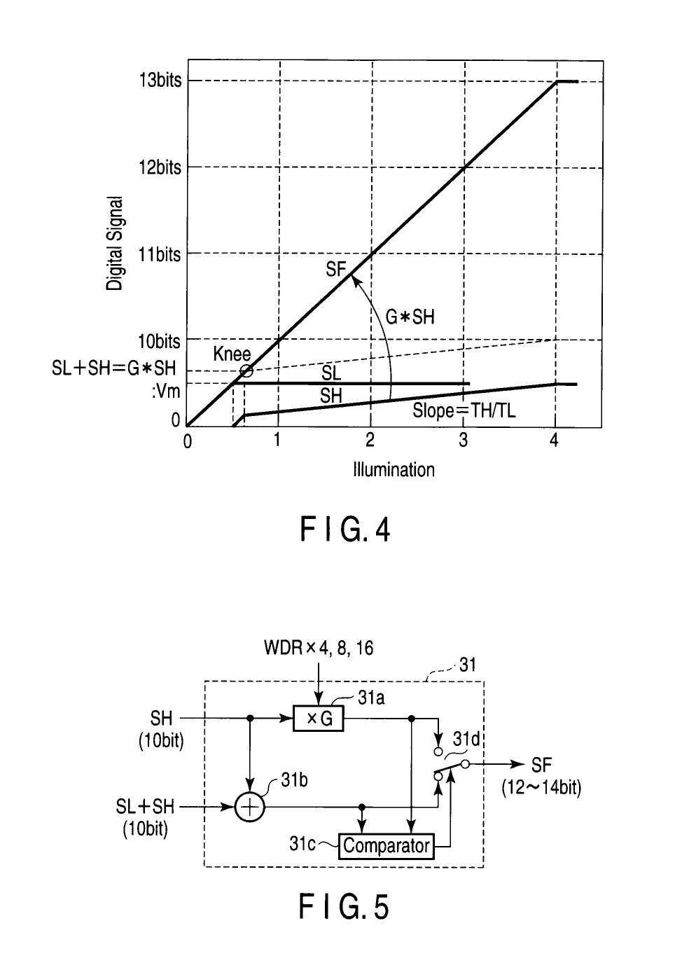

FIG. 4 is a graph showing a signal SF obtained by the linear synthesis circuit 31 from the result. Specifically, the linear synthesis circuit 31 compares a signal obtained by multiplying signal SH by short-time and long-time exposure ratio G=TL/TH with a signal SL+SH, and then, selects a larger signal of the two signals as a signal SH. Therefore, the linear synthesis circuit 31 outputs a signal SF having a dynamic range expanded to 12 to 14 bits from 10-bit signal SH and signal SL+SH.

FIG. 5 is a block diagram showing one example of the configuration of the linear synthesis circuit 31. A signal SH is supplied to a multiplier 31a while being supplied to one input terminal of an adder 31b. A signal SL+SH is supplied to the other input terminal of the adder 31b. The multiplier 31a multiplies signal SH by G. The value of G is set by means of the controller 34 in accordance with modes WDR×4, ×8 and ×16 of an expansion described later. An output signal of the multiplier 31a and an output signal of the adder 31b are supplied to a selector 31b while being supplied to a comparator 31c. The comparator 31c compares the output signal of the multiplier 31a with the output signal of the adder 31b, and thereafter, controls the selector in accordance with the result of comparison. The selector 31d selects a larger signal of the output from the multiplier 31a or the adder 31b in accordance with an output signal of the comparator 31c.

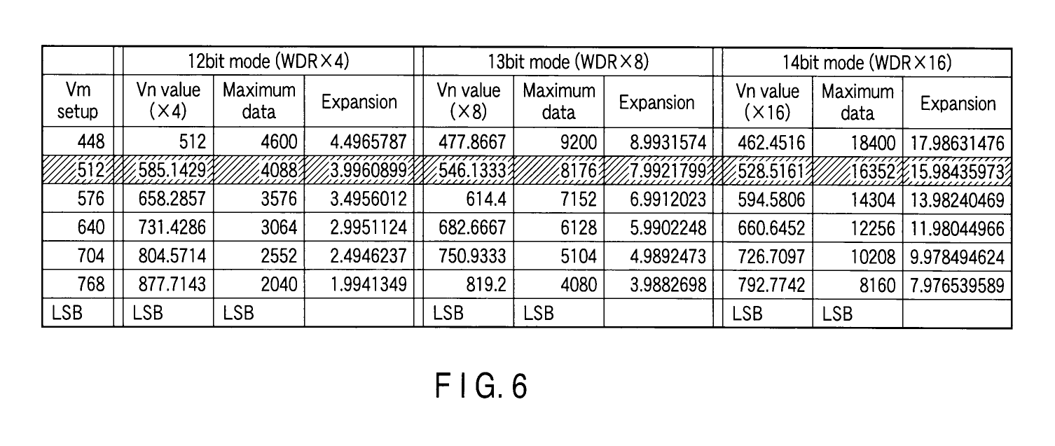

FIG. 6 is a table showing the relationship between a medium read voltage Vm and a dynamic range expansion mode. As described above, signal SL and signal SL+SH are each sampled by means of the ADC 14. In this case, the value of Vm is set so that it has 512 LSB in order to obtain an exposure ratio TL:TH=8:1. In this way, the maximum number of bits is 12 bits; therefore, a dynamic range is expanded to four times (WDR×4).

According to the same condition as above, the exposure ratio is set to 16:1 and 32:1, and thereby, the maximum number of bits is 13 bits and 14 bits. Therefore, a dynamic range is expanded to eight times (WDR×8) and 16 times (WDR×16) as shown in FIG. 6.

As can be seen from FIG. 6, the expansion of the dynamic range depends on the value of Vm in addition to the exposure ratio G. From FIG. 6, it is preferable that the value of Vm is set to 512 LSB in order to control the expansion to a predetermined number of bits so that the maximum dynamic range is obtained. Vn shown in FIG. 6 denotes a knee point (i.e., point where a break line generates in a graph showing a quantity of light to data) by an actual sensor. As can be also seen from FIG. 4, the knee point is slightly higher than the value of Vm. The relationship between the value of Vm and the value of knee point Vn is as shown in the following equation (2). The value of Vn shown in FIG. 6 is obtained from the following equation (2).

Vm=Vn/(TL/(TL−TH)) (2)

Hereinafter, the following modes of the expansion will be set; specifically, a WDR×4 mode (12-bit mode), a WDR×8 mode (13-bit mode) and a WDR×16 mode (14-bit mode) will be explained. However, this embodiment is not limited to the expansions.

According to a conventional case, it is desired that the value of Vm is set to 512 LSB in the light of an expansion. However, the conventional case gives no consideration to the quality of long-time exposure signal (signal SL) and short-time exposure signal (signal SH). Specifically, the quality of signal SL rather than signal SH is relatively preferable in an SNR and a quantization error. For example, it is desired that an important subject such as a human face is controlled so that it is involved in signal SL. As can be seen from FIG. 6, when the value Vm is 512 LSB, the value of Vn is 585 LSB. For this reason, if the face luminance is close to 600 LSB, the face as an important subject is close to the signal SH side; as a result, the image quality of the face is reduced.

In general, according to the standard suitable as an image, the face luminance is set to around 650 LSB. According to this embodiment, the value of Vm for determining the knee point is determined after being fed-back from luminance information of an important subject in auto-exposure (AE) control.

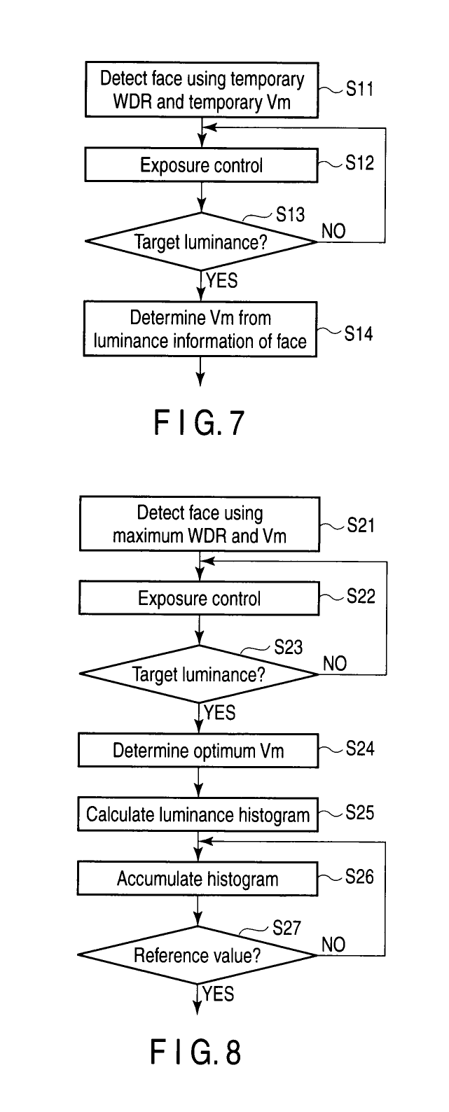

FIG. 7 is a flowchart to explain the operation of this embodiment. In FIG. 1, the controller 34 sets a temporary WDR×4 mode and a temporary value of Vm. The sensor core unit 11 outputs an image signal based on the WDR×4 mode and value of Vm. A signal SH and a signal SL+SH output from the sensor core unit 11 is supplied to the linear synthesis circuit 31, and then, synthesized therein. A signal SF output from the linear synthesis circuit 31 is supplied to the signal processing circuit 32. The signal processing circuit 32 executes a shading correction, a noise cancel and a de-mosaic processing with respect to signal SF. In this way, signal SF is converted from a Bayer-format signal SF to an RGB-format signal SF_RGB. Signal SF_RGB output from the signal processing circuit 32 is supplied to the AE detection unit 33. The AE detection unit 33 makes a YUV conversion with respect to signal SF_RGB, and thus, a luminance signal (Y signal) is generated, and thereafter, face detection is made using the luminance signal (S11). In this case, if the luminance signal has an extremely high or low luminance in the initial stage of the detection, it is difficult to detect the face. For this reason, the luminance is optimized according to exposure control.

Specifically, the detected luminance information output from the AE detection unit 33 is supplied to the controller 34. Based on the supplied luminance information, the controller 34 executes exposure control so that the luminance is set to a target luminance of the face as an important subject, for example, 650 LSB (S12, S13). In other words, the controller 34 generates a control signal based on the luminance information supplied from the AE detection unit 33, and thereafter, supplies the signal to the timing generator 19. The timing generator 19 generates various pulse signals in accordance with the control signal, and thereafter, supplies them to the sensor core unit 11. Signals SH and SL+SH read from the sensor core unit 11 are successively processed according to loop of the linear synthesis circuit 31, the image signal processing circuit 32, the AE detection unit 33 and the controller 34.

AE control is carried out in the manner described above; as a result, face luminance information as an important subject converges on 600 LSB, for example. In this case, the controller 34 again converts the luminance information to RGB. For example, if the RGB has a relation of R:G:B=400:600:500 LSB, the maximum value of them, that is, G=600 LSB is obtained. When G=600 LSB, the knee point Vn is Vn=658 from FIG. 6. When the value of Vn is determined, the value of Vm is operated using the equation (2). Therefore, in this case, Vm=576 is determined. In other words, when AE control converges and further, the face luminance is determined, the controller 34 determines the value of Vm so that the face portion has a signal SL. The value of Vm is supplied to the sensor core unit 11 via the timing generator 19.

As described above, the value of Vm is determined in cooperation with AE control, and thereby, it is possible to take an image having an expanded dynamic range without reducing the image quality of an important subject such as a face.

In this case, a compression ratio of signal SH becomes higher than the case of Vm=512 LSB. For this reason, gradation on the signal SH side is relatively lost. This shows the trade-off between signal SL and signal SH given as a main point depending on a knee point position. In other words, according to this embodiment, the trade-off is optimized from luminance information in accordance with a shooting scene, that is, a face as an important subject.

Likewise, even if a face as an important subject is dark in some degree, there is a shooting scene desired to improve gradation characteristic of a high luminance portion. For example, there is the case of taking a scene outside a window from the room, and simultaneously, taking a human face in the room. In this case, a target luminance of the face is reduced to 520 LSB, and simultaneously, the value of Vm is reduced to 448 LSB. In this way, the face is involved in the signal SL side, and the compression ratio of signal SH is relaxed, and thereby, the gradation characteristic is improved. Of course, the value of Vm may be further reduced so that gradation characteristic on the signal SH side is improved.

The series of operation is carried out in a state that a shutter is half-pushed or a preview operating state if this embodiment is applied to a digital camera, for example.

Then, the shutter is operated, and thereafter, a signal SF_RGB of an image expanding the dynamic range is obtained without reducing the image quality of an important subject. Signal SF_RGB is subjected to signal processings such as white balance and linear matrix by means of the image signal processing circuit 32 shown in FIG. 1, and thereafter, supplied to the dynamic range compression unit 35. The dynamic range compression unit 35 compresses signal SF_RGB having the expanded dynamic range into a narrow dynamic range corresponding to a display device (not shown). Specifically, the dynamic range compression unit 35 compresses signal SF_RGB into sRGB-format 8 bits, for example. In order to perform the compression, for example, a high-luminance knee compression circuit and a Retinex processing circuit are applicable. In this case, considering a quantization error, the dynamic range compression unit 35 compresses signal SFRGB into 10 bits, and thereafter, supplies it to the output unit 36. The output unit 36 executes gamma processing with respect to the compressed signal to output a sRGB-format 8-bit signal from 10 bits.

According to the first embodiment, AE control is carried out based on luminance information of a face as an important subject. In a state that the AE control converges, the medium read voltage of the sensor, that is, the value of Vm is determined. Therefore, the knee point of the sensor is set higher than the value of Vm, and thereby, the image quality of a face as an important subject is improved.

If the accuracy of the AE control is high and high-accurately converges on a target luminance level, no feedback control may be carried out like the first embodiment. In this case, an accurate value of Vm is anticipated before AE control; therefore, an anticipated value of Vm is set in place of the temporary value of Vm, and thus, feed-forward control may be carried out.

### Modification Example

The first embodiment has described the shooting scene to which Vm=448 LSB is applied. In this case, the expansion exceeds four times; for this reason, there is the possibility that data is saturated in the WDR×14 bit mode.

Thus, a method of optimizing a WDR mode will be described below with reference to FIG. 8.

In this case, a WDR mode is set to the maximum. According to this modification example, a WDR×16 mode is the maximum, and when Vm=512 LSB is set; a dynamic range is expanded by 14 bits in the maximum. AE control is carried out based on luminance information of a face as an important subject from an image having an expanded dynamic range like the first embodiment (S21 to S23).

The AE control converges, and thereafter, the controller 34 determines the optimum value of Vm in the WDR×16 mode (S24).

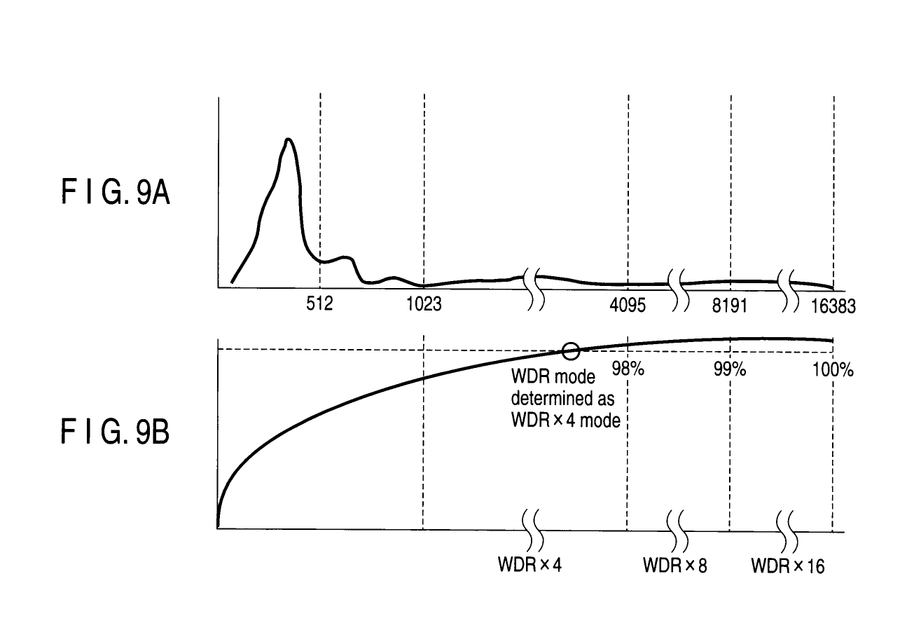

As shown in FIG. 9A, a luminance histogram after the value of Vm is changed is calculated (S25). The calculated luminance histogram is accumulated (S26). A selection reference of the accumulated histogram and a predetermined WDR mode, for example, the optimum WDR mode such that data is not saturated more than a predetermined value from 95%, is determined (S27). According to the case shown in FIG. 9B, a WDR×4 mode is determined as the optimum WDR mode. Specifically, it is preferable that the WDR mode is a small mode such as a WDR×4 mode in the light of a SNR and a compression ratio (gradation characteristic). Therefore, a smaller WDR mode is selected so long as data is not saturated more than a predetermined value.

According to the modification example, the value of Vm is determined based on luminance information of a face as an important subject. Thereafter, a WDR mode is optimized based on accumulated histogram of the luminance information. Therefore, this serves to prevent white defect while to reduce contrast compression on the high-luminance side to the minimum. In this way, it is possible to provide a high image quality in a wide dynamic range image.

### Second Embodiment

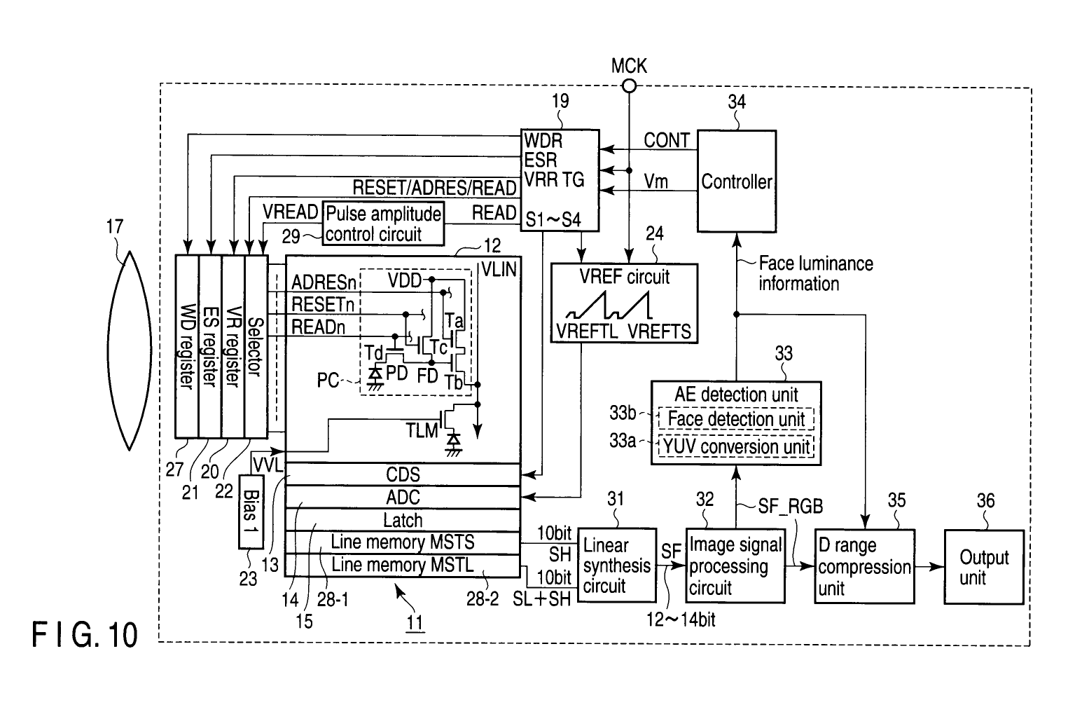

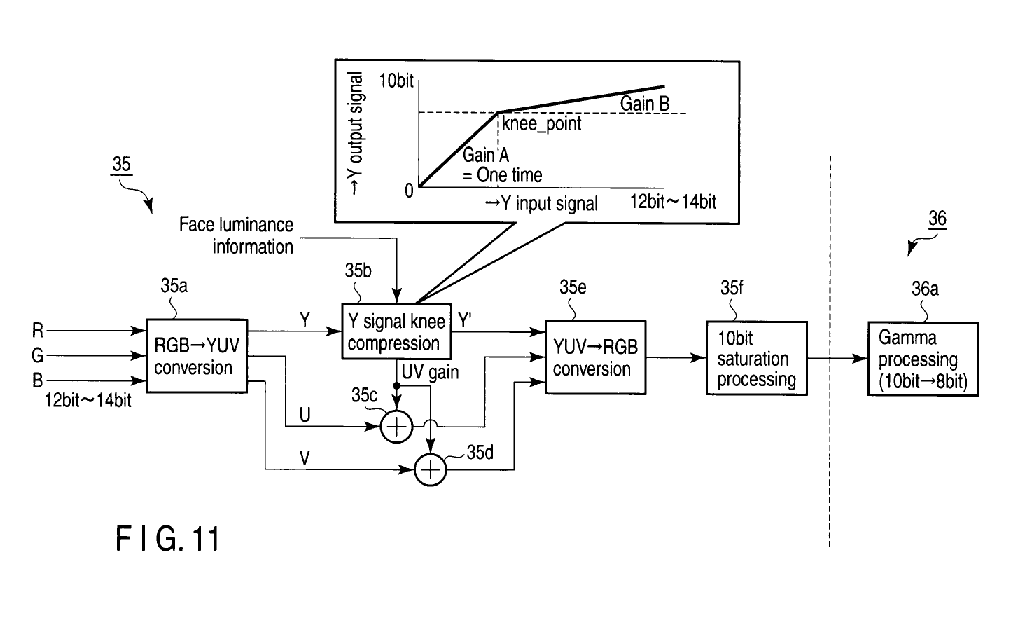

FIGS. 10 and 11 show a second embodiment, and the same reference numerals are used to designate portions identical to the first embodiment. Hereinafter, only portions different from the first embodiment will be described.

As described in the first embodiment, when a display device displays an image having an expanded dynamic range, the image is set to a bit map (BMP) file narrow range, for example, sRGB 8 bits. For this reason, there is a need to effectively compress the image having an expanded dynamic range.

According to the second embodiment, luminance information of a face as an important subject is used to compress a dynamic range. Specifically, as shown in FIG. 10, luminance information of a face output from an AE detection unit 33 is supplied to a dynamic range compression unit 35.

FIG. 11 shows one example of the configuration of the dynamic range compression unit 35; however, the present invention is not limited to the configuration. The dynamic range compression unit 35 includes a converter 35a, a compressor 35b, a converter 35e and a saturation processor 35f. Specifically, the converter 35a converts an RGB signal to a YUV signal. The compressor 35b knee-compresses a luminance signal supplied from the converter 35a. The converter 35e converts a luminance signal Y, a U signal and a V signal supplied from the compressor 35b, multipliers 35c and 35d to an RGB signal. The saturation processor 35f executes a processing for saturating an output signal of the converter 35e to 10 bits.

A knee point position is important in data compression as well as data expansion. Thus, according to the second embodiment, luminance information of a face output from the AE detection unit 33 is supplied to the compressor 35b for executing knee compression. The compressor 35b determines a knee point based on luminance information of a face as an important subject to compress a luminance signal. Therefore, signal linear characteristic of a face is secured while gradation of a high-light portion is compressed to the minimum. In this way, it is possible to generate a high-quality dynamic range image.

The second embodiment has described fixed knee compression of a luminance signal. This embodiment is applicable to dynamic range compression using the property of retina such as a Retinex processing circuit. In this case, knee compression is carried out in compressing illumination light. Therefore, the second embodiment is applied to the knee compression. In this way, it is possible to determine a knee point based on illumination light, and to compress the illumination light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image signal processing device comprising:
an imaging unit configured to generate first and second image signals imaged using different exposure time based on a reference read voltage;
a synthesis circuit configured to synthesize the first and second image signals generated by the imaging unit;
a detection unit configured to detect luminance information of a specified subject using a synthesized image signal outputting from the synthesis circuit; and
a controller configured to control the reference read voltage of the imaging unit, the controller configured to determine a first knee point based on luminance information of a specified subject detected by the detection unit, and to control the first knee point according to the reference read voltage.

2. The device according to claim 1, wherein the controller controls the reference read voltage so that the first knee point is set higher than the luminance information of a specified subject.

3. The device according to claim 1, wherein the controller sets an expansion number of bits to the maximum to determine the reference read voltage, and determines the optimum expansion number of bits from an accumulated value of a histogram of the luminance information.

4. The device according to claim 1, further comprising:
a compression unit configured to compress a dynamic range of a synthesized image signal outputting from the synthesis circuit.

5. The device according to claim 4, wherein the compression unit determines a second knee point based on the luminance information outputting from the detection unit.

6. The device according to claim 5, wherein the compression unit comprises:
a first converter configured to convert an RGB signal to a YUV signal including a luminance signal;
a compressor configured to compress the luminance signal output from the first converter based on the luminance information output from the detection unit; and
a second converter configured to convert a compressed luminance signal supplied from the compressor, a U signal and a V signal supplied from the first converter to an RGB signal.

7. The device according to claim 5, wherein the synthesis circuit includes:
an adder configured to add the first and second image signals;
a multiplier configured to multiply the first image signal by a signal showing an expansion;
a comparator configured to compare an output signal of the adder with an output signal of the multiplier; and
a selector configured to select one of outputs from the adder and the multiplier based on an output signal of the comparator.

8. The device according to claim 7, wherein the selector selects a larger signal of output signals from the adder and the multiplier.

9. An image signal processing method comprising:
imaging a specified subject based on a reference read voltage;
setting luminance information of the specified subject to a target luminance information using exposure control; and
determining a first knee point based on the target luminance information, and controlling the reference read voltage according to the first knee point.

10. The method according to claim 9, further comprising:
compressing a dynamic range of the synthesized image signal.

11. The method according to claim 10, further comprising:
determining a second knee point based on the detected luminance information.

12. An imaging signal processing method comprising:
imaging a specified subject having an expanded dynamic range based on a reference read voltage;
setting luminance information of the specified subject to a target luminance information using exposure control;
determining a reference read voltage of the dynamic range based on the target luminance information;
calculating a luminance histogram of the determined reference read voltage;
accumulating the calculated histogram; and
determining a dynamic range based on the accumulated histogram and a predetermined selection reference.

13. The method according to claim 12, wherein according to the selection reference, a smaller dynamic range is selected from a plurality of dynamic ranges.
